(19) United States
(12) Patent Application Publication
(10) Pub. No.: US 2016/0312463 A1
(43) Pub. Date: Oct. 27, 2016

(54) Wall Light

(71) Applicant: Kingspan Insulated Panels, Inc., Deland, FL (US)

(72) Inventors: Brian GLANCY, Toronto (CA); Taylor VAIL, St. Augustine, FL (US); Gabriel MORRIS, Aurora (CA)

(21) Appl. No.: 15/131,475

(22) Filed: Apr. 18, 2016

Related U.S. Application Data
(60) Provisional application No. 62/150,506, filed on Apr. 21, 2015.

(51) Int. Cl. E04B 2/72; E06B 3/54; E04B 2/74

(52) U.S. Cl. CPC E04B 2/72; E04B 2/7455; E06B 3/54; E06B 3/5427; E06B 3/549

(57) ABSTRACT

A wall light panel has an inner window light and an outer window light sandwiching a support frame. A pair of caps is coupled with the lights and frame on opposing edges. The caps have a configuration to mate with adjacent panels to enable the wall light panel to be integrally connected with adjacent panels.

### CROSS-REFERENCE TO RELATED APPLICATION

This application claims the benefit of U.S. Provisional Application No. 62/150,506, filed on Apr. 21, 2015. The entire disclosure of the above application is incorporated herein by reference.

### FIELD

The present disclosure relates to building lighting and, more particularly, to building walls that include an integrally connected wall light panel.

### BACKGROUND

A problem building light panels have is that they are not efficient insulators. The rate of heat loss through these translucent panels is relatively high. Another problem is that conventional wall light panels are relatively thick to achieve desired insulation and expandability properties. Thus, where available, the panels are expensive. Generally, conventional integrated windows are used that are particularly expensive.

The present disclosure provides the art with a translucent wall panel that provides improved insulation. The rate of heat loss is lower than conventional window panels. Thermal resistance is comparable to the insulated wall panels. Additionally, the light panel connects between adjacent insulated wall panels.

### SUMMARY

According to the present disclosure, a wall light comprises an inner window light and an outer window light. A support frame is positioned between the inner window light and the outer window light. A pair of caps secures to the inner window light, outer window light and support frame on opposing edges. The caps have a configuration to mate with adjacent panels to enable the wall light panel to be connected with adjacent panels to build a wall. Each cap includes a first and second member. The first members connect with adjacent panels. The second member couples with the first member to provide a reveal molding on the outer window light. One of the first members has a receiving member to mate with an adjacent panel projecting member. The outer first member has a projecting member to mate with an adjacent panel receiving member. The caps are an extruded metal member. The support frame is a metal member. The support frame is positioned about the periphery of the window lights.

According to a second aspect of the disclosure, a building wall comprises a plurality of interconnecting insulated panels. Opposing edges of the insulated panels include mating members. At least one light panel is connected with at least one of the insulated panels. The at least one light panel comprises an inner window light and an outer window light. A support frame is positioned between the inner window light and the outer window light. A pair of caps secures to the inner window light, outer window light and support frame on opposing edges. The caps have a configuration to mate with the adjacent insulataed panels to enable the wall light panel to be connected with adjacent insulated panels to build a wall. Each cap includes a first and second member. The first members connect with the adjacent insulation panels. The second member couples with the first member to provide a reveal molding on the outer window light. One of the first members has a receiving member to mate with the adjacent insulating panel projecting member. The outer first member has a projecting member to mate with the adjacent insulating panel receiving member. The caps are an extruded metal member. The support frame is a metal member. The support frame is positioned about the periphery of the window lights.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a building in accordance with the disclosure.

FIG. 2 is a cross-section view along lines 2-2 thereof.

FIG. 3 is a perspective view of a wall light panel.

FIG. 4 is a cross-sectional exploded view of FIG. 3.

FIG. 5 is a cross-sectional view of FIG. 2.

FIG. 6 is a cross-sectional view of FIG. 2

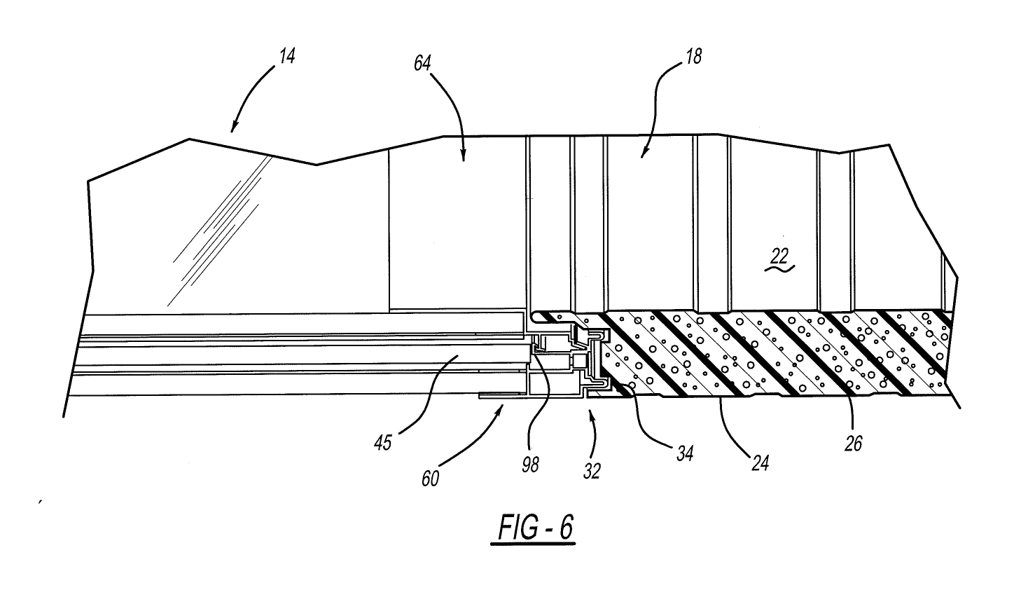

FIG. 7 is a second embodiment of the building wall.

FIG. 8 is another embodiment of the wall light panel.

### DETAILED DESCRIPTION

Example embodiments will now be described more fully with reference to the accompanying drawings.

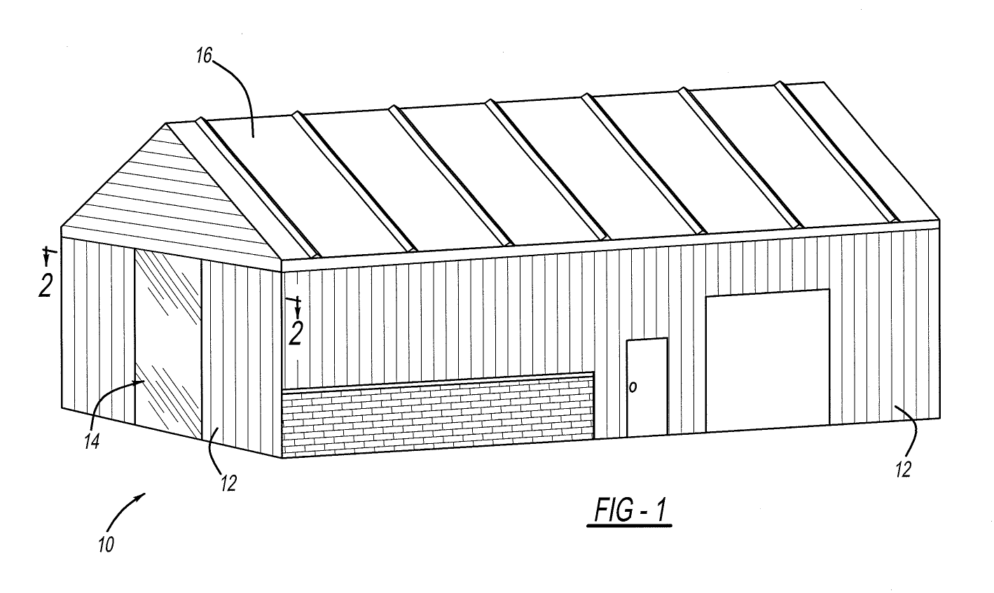

Turning to the figures, particularly FIG. 1, a building is illustrated and designated with the reference numeral 10. The building includes walls 12, one with a wall light panel 14 and a roof 16.

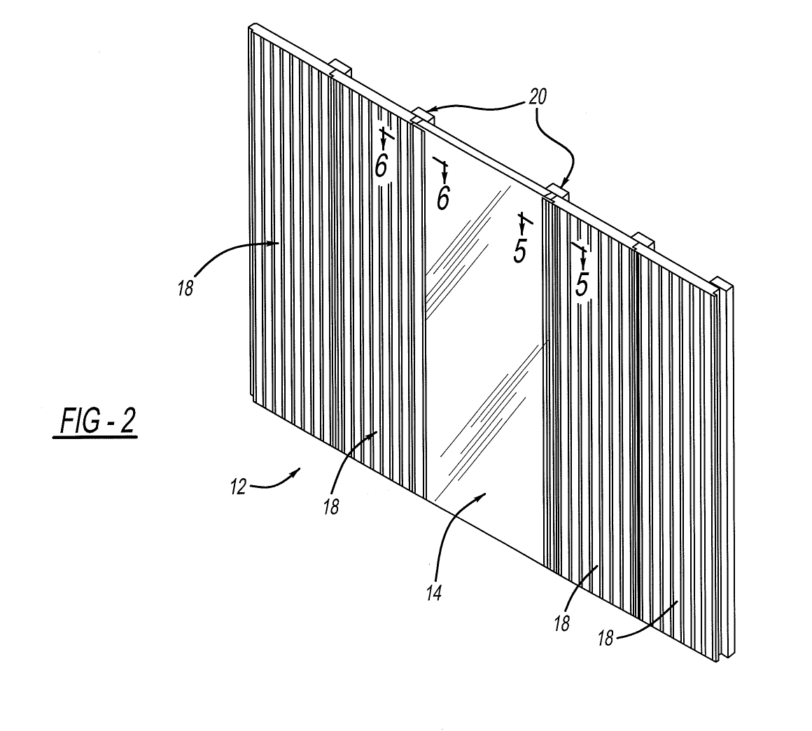

FIG. 2 illustrates a building wall 12 with a plurality of insulated panels 18 as well as the wall light panel 14. The insulated panels 18 and the wall light panel 14 are secured to a framing structure 20. The insulated panels 18 include an outer skin 22 and inner skin 24 with insulation 26 sandwiched between the two. One end includes a male edge 28 with at least one projection member 30. The other edge 32 includes a receiving member 34 that will receive the at least one projection member 30 so that the wall panels 18 and wall window panel 14 can be connected in a mating or interlocking fashion. Additionally, fasteners are passed through the edges to secure the panels 18, 14 with the frame 20.

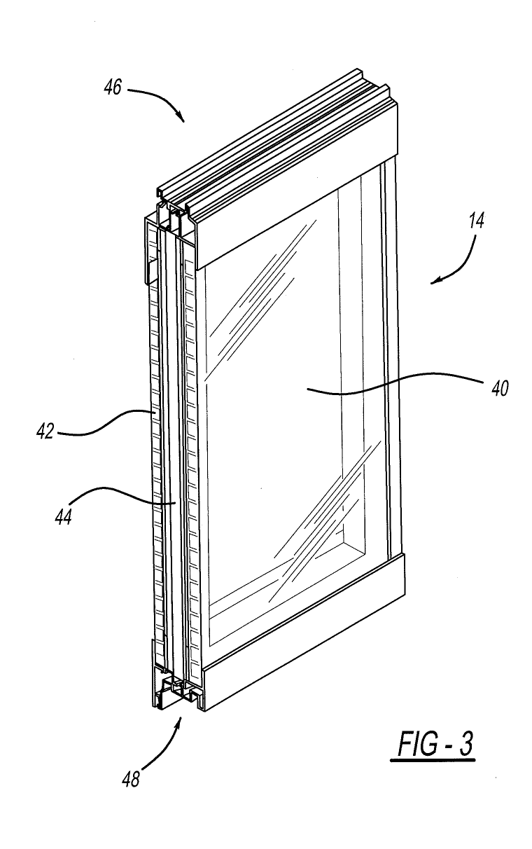

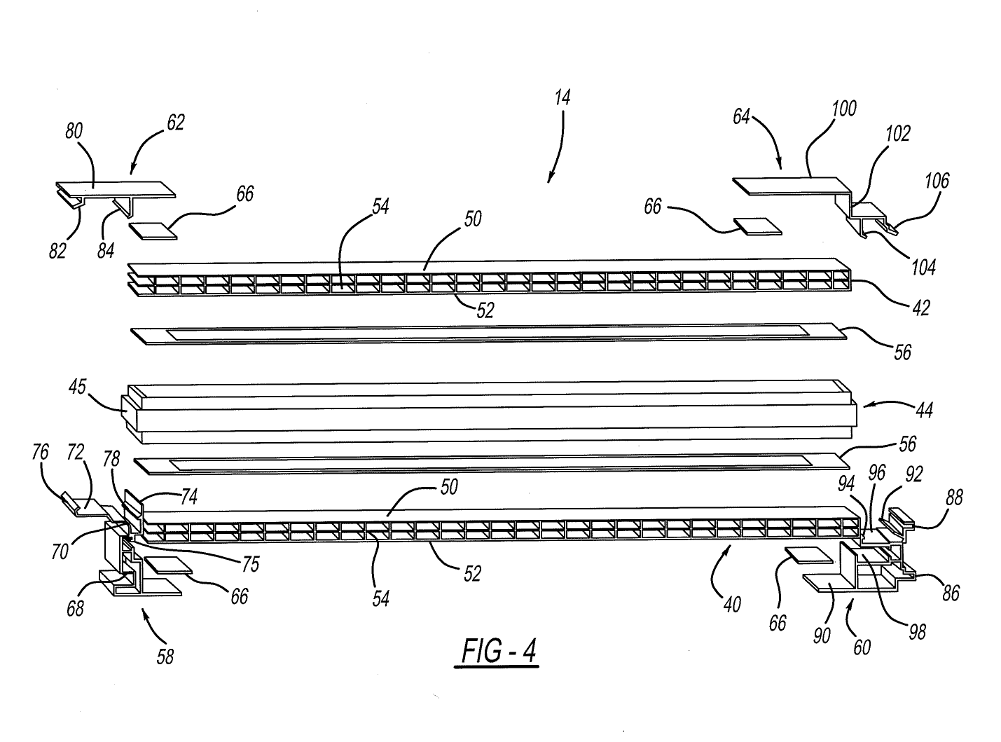

Turning to FIGS. 3 and 4, the wall light panel 14 is illustrated. The wall light panel 14 includes an inner window light 40 and an outer window light 42. A frame member 44 is sandwiched between the window lights 40, 42. A pair of caps 46, 48 is secured to opposing edges of the wall light panel 14.

The inner window light 40 and outer window light 42 are substantially the same. The window lights 40, 42 are preferably manufactured from non-profiled polycarbonate material. The window lights 40, 42 may be of a desired color. The window lights 40, 42 include a first surface 50 and a second surface 52. A plurality of baffles 54 are positioned between the two translucent surfaces 50, 52. The baffles 54 provide an air gap between the surfaces 50, 52 to provide increased thermal resistance and ultimately a higher R value for the wall light panel 14.

A frame 44 is sandwiched between the window lights 40, 42. The frame has an overall configuration that matches the periphery of the window lights 40, 42. Here, in FIGS. 3 and 4, it is illustrated as a rectangular. Additionally, the frame 44 is formed from an aluminum material. The frame 44 includes a peripheral band 45. Preferably, adhesive members 56 are positioned along the borders of the aluminum frame 44. The adhesive members 56 adhesively secures the window lights 40, 42 to the frame 44. The frame 44 provides an air gap between the inner window light 40 and the outer window light 42. This creates an air gap between the inner window light 40 and outer window light 42. Thus, the thermal resistance and R value for the wall window panel 14 has an R value between 15 to 54 depending upon the thickness of the wall window panel.

The caps 48, 46 both include first members 58, 60 and the second members 62, 64, respectively. The first members 58, 60 are adhered to the inner window light 40 by an adhesive 66. Additionally, the adhesive 66 retains the second members 62, 64 on the outer window light 42.

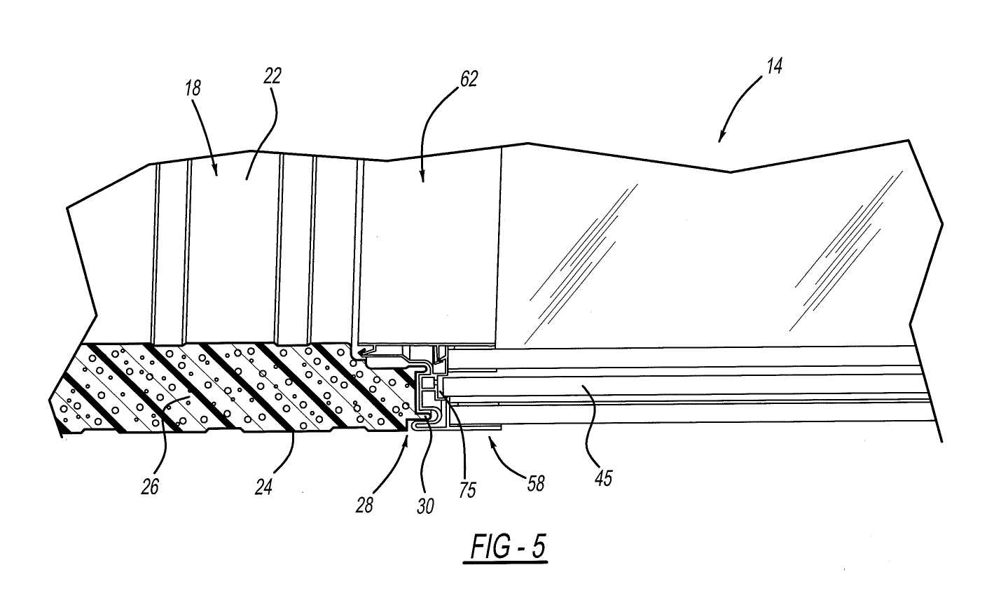

The first member 58 includes at least one, illustrated as a pair of receiving members 68, 70, that receive projections 30 of the insulated panel member 18 as illustrated in FIG. 5. Thus, the first member 58 would be viewed as a female receiving member. A flange 72 extends from the receiving member 70 and is substantially parallel to the inner window light 40. A second flange 74 extends from the receiving member and is substantially perpendicular to the window panel 40. Additionally, the first member 58 includes a cutout 75 to receive a peripheral band 45 on the frame 44. The band 45 fits in the cutout 75 to maintain the first member 58 onto the frame 44. The flange 72 includes an upturned edge 76. The second flange 74 includes a bead barb 78. The second member 62 has a substantially flat surface 80 that acts as a reveal molding on the outer window light 42. A pair of projections 82, 84 extends from the planar surface 80. The projections 82, 84 mate with upturned end 76 and bead barb 78 to frictionally hold the members 58, 62 together. Thus, the caps act as an end mullion to connect the wall light panel 14 with adjacent wall light panels or insulating panels 18.

The first member 60 includes a pair of projecting members 86, 88 that mate with the receiving members 34 of the adjacent insulated panel 18. The member 60 includes a planar flange 90, as does member 58, to receive the adhesive 66. The first member 60 also includes an angled flange 92 and a second flange 94 perpendicular to the window light 40. The flange 94 includes a bead barb 96. The first member 60 and second member 64, when positioned together, define a cutout 98 that receives the peripheral band 45 of the frame 44. This helps to position the first and second members 60, 64 onto the frame 44.

The second member 64 includes a planar portion 100. The planar portion 100 acts as a reveal molding for the wall panel light 14. A flange 102, having an overall L-shape, extends from the surface 100 at its one end. A pair of projections 104, 106 extends from the flange 102. The projections 104, 106 frictionally engage the barb 96 and angled flange 92 to frictionally hold the first and second members 60, 64 together. Again, the cap acts as a mullion to provide support and rigidity as well as securement with the insulated panels or additional wall light panels.

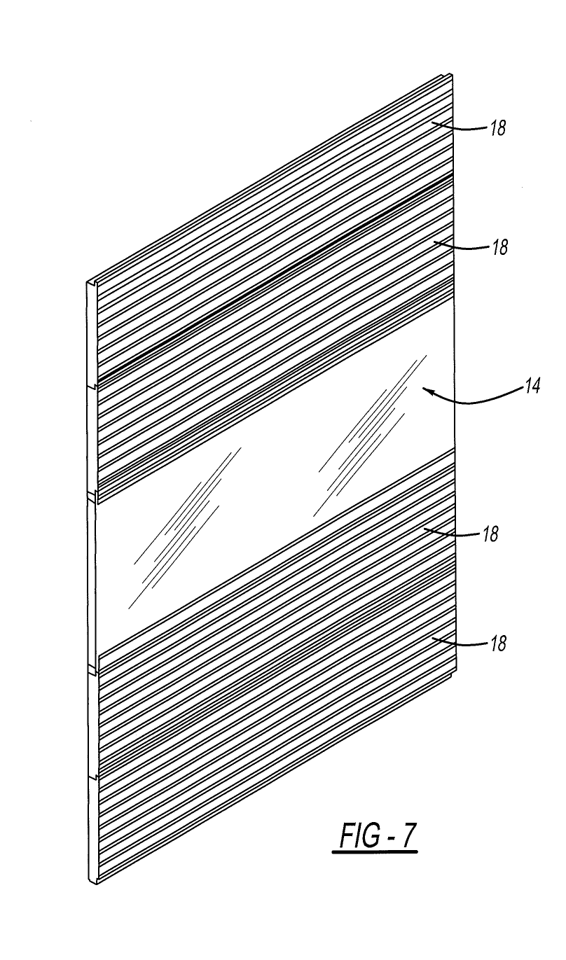

FIG. 7 is a second embodiment of the disclosure. In FIG. 7, the insulated panels 18 and wall light panel 14 are the same as described above. Here, the panels 18, 14 are positioned horizontally.

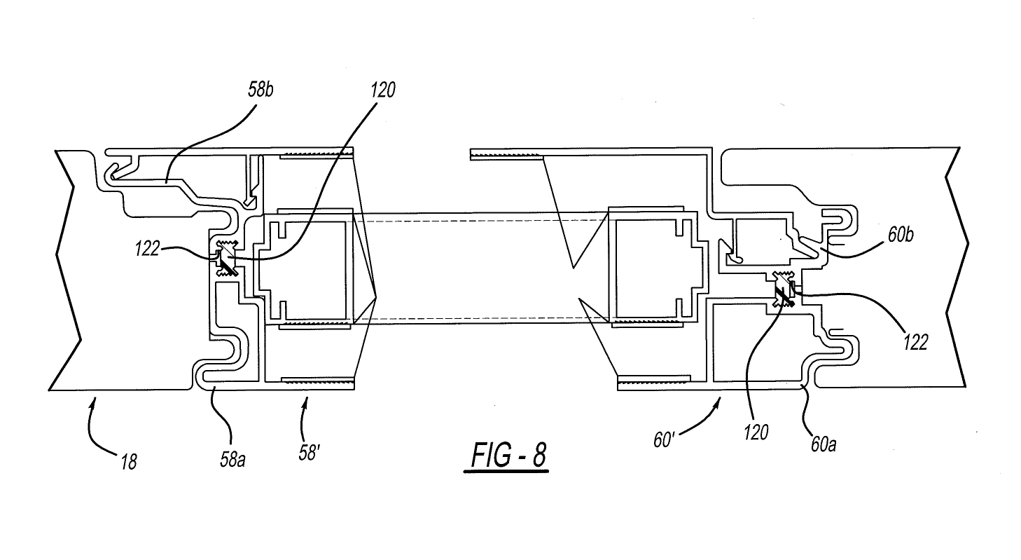

Turning to FIG. 8, another embodiment of the present disclosure is illustrated. Here, the wall light panel is substantially the same as that illustrated in FIGS. 3 and 4, however, a thermal break has been added to the first members 58′, 60′. The thermal brake 120 is added into a channel 122 in the first members 58′, 60′. The thermal brake 120 is manufactured from a thermoplastic material. The thermal brake material divides the first members 58, 60 into two portions 58a, 58b and 60a, 60b. The thermal brake 120 reduces the heat transfer through the first members 58′, 60′. Thus, the thermal brake prohibits transfer of heat along the first and second members. Thus, when the environmental temperature is cold, less heat from the inside of the building will be drawn to the ambient conditions via the aluminum members 58′, 60′. Likewise, when the ambient conditions are hot, less heat will be drawn from the outside into the inside of the building.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A wall light panel comprising:
an inner window light and an outer window light;
a support frame positioned between the inner window light and the outer window light;
a pair of caps coupled with the inner window light, outer window light and support frame on opposing edges, the caps having a configuration for mating with an adjacent panel to enable the wall light panel to be connected with the adjacent panel to build a wall.

2. The wall light panel of claim 1, wherein the caps further comprise a first and second member, the first member connecting with adjacent panels and the second member coupling with the first member and providing a reveal molding on the outer window light.

3. The wall light panel of claim 2, wherein one first member has a receiving member for mating with an adjacent panel projecting member and the other first member has a projecting member for mating with an adjacent panel receiving member.

4. The wall light panel of claim 1, wherein the caps are an extruded metal member.

5. The wall light panel of claim 1, wherein the support frame is a metal member.

6. The wall light panel of claim 1, wherein the support frame is positioned about the periphery of the window lights.

7. A building wall comprising:
a plurality of interconnecting panels, opposing edges of the interconnecting panels having mating members;
at least one light panel, the at least one light panel comprising:
an inner window light and an outer window light;
a support frame positioned between the inner window light and the outer window light;
a pair of caps coupled with the inner window light, outer window light and support frame on opposing edges, the caps having a configuration for mating with at least one adjacent panel of the plurality of interconnecting panels to enable the wall light panel to be connected with adjacent panels of the plurality of interconnecting panels to build a wall.

8. The wall light panel of claim 7, wherein the caps further comprise a first and second member, the first member connecting with adjacent panels and the second member coupling with the first member and providing a reveal molding on the outer window light.

9. The wall light panel of claim 8, wherein one first member has a receiving member for mating with an adjacent panel projecting member and the other first member has a projecting member for mating with an adjacent panel receiving member.

10. The wall light panel of claim 7, wherein the caps are an extruded metal member.

11. The wall light panel of claim 7, wherein the support frame is a metal member.

12. The wall light panel of claim 7, wherein the support frame is positioned about the periphery of the window lights.

13. The wall light panel of claim 1, further comprising a thermal brake in the support frame.

14. The wall light panel of claim 7, further comprising a thermal bake in the support frame.
